(19) United States
(12) Patent Application Publication
(10) Pub. No.: US 2015/0017074 A1
(43) Pub. Date: Jan. 15, 2015

(54) EXHAUST GAS CLEANING CATALYST APPARATUS

(71) Applicant: CALSONIC KANSEI CORPORATION, Saitama (JP)

(72) Inventor: Shunsuke Moritsugu, Saitama (JP)

(21) Appl. No.: 14/326,967

(22) Filed: Jul. 9, 2014

(30) Foreign Application Priority Data
Jul. 12, 2013 (JP) 2013-146255

(51) Int. Cl. B01D 53/94

(52) U.S. Cl. CPC B01D 53/94
USPC 422/180

(57) ABSTRACT

An exhaust gas cleaning catalyst apparatus includes: a catalyst carrier; an outer tube for storing the catalyst carrier; and a holding member interposed between the catalyst carrier and the outer tube in contact with the outer peripheral surface of the catalyst carrier and the inner peripheral surface of the outer tube, wherein a clearance between the inner peripheral surface of the outer tube and the outer peripheral surface of the catalyst carrier narrows toward the flow direction of exhaust gas.

### BACKGROUND

1. Field of the Invention

The invention relates to an exhaust gas cleaning catalyst apparatus for cleaning exhaust gases discharged from, for example, the engine of an automobile.

2. Description of the Related Art

As a conventional exhaust gas cleaning catalyst apparatus, there is known an apparatus disclosed in JP-A-S61-142316. This exhaust gas cleaning catalyst apparatus is structured such that a catalyst carrier constituted of a ceramic-made honeycomb catalyst is stored in the outer tube of a metal-made case through a seal mat serving as a holding member made of heat-resistant fibers and including a sliding layer at least on one of its side surfaces.

However, the cited conventional exhaust gas cleaning catalyst apparatus has the below-described problem.

That is, in such conventional exhaust gas cleaning catalyst apparatus, while the holding member is interposed between the catalyst carrier and outer tube, the holding member must be press-fitted for holding it in high density. In this case, attention must be paid to prevent the holding member from protruding from the outer tube and the catalyst carrier from cracking. This makes it very difficult to manufacture the apparatus.

Also, in order to avoid the problem that the catalyst carrier is shifted in position or is removed from the outer tube due to the flow of the exhaust gas, the variation of the holding member must be controlled severely to secure its performance for holding the catalyst carrier.

### SUMMARY

The invention aims at solving the above problems and thus it is an object of the invention to provide an exhaust gas cleaning catalyst apparatus which can be manufactured further simply and can satisfy the performance of the holding member for holding the catalyst carrier without controlling severely the variation of the holding member.

To attain this object, an exhaust gas cleaning catalyst apparatus of the invention comprises: a catalyst carrier; an outer tube for storing the catalyst carrier; and a holding member interposed between the catalyst carrier and outer tube in contact with the outer peripheral surface of the catalyst carrier and the inner peripheral surface of the outer tube, wherein a clearance between the inner peripheral surface of the outer tube and the outer peripheral surface of the catalyst carrier narrows toward the flow direction of an exhaust gas.

Preferably, the inner peripheral surface of the outer tube and the outer peripheral surface of the holding member may be inclined toward inwardly of the outer tube and holding member, and the inner peripheral surface of the holding member and the outer peripheral surface of the catalyst carrier may extend parallel to the center axes of the outer tube and holding member.

When compared with the conventional apparatus, the exhaust gas cleaning catalyst apparatus of the invention can satisfy the performance of the holding member for holding the catalyst carrier without controlling severely the variation of the holding member. And, the manufacture of the exhaust gas cleaning catalyst apparatus can be simplified further.

Since the inner peripheral surface of the outer tube and the outer peripheral surface of the holding member are inclined toward inwardly of the outer tube and holding member, and the inner peripheral surface of the holding member and the outer peripheral surface of the catalyst carrier extend parallel to the center axes of the outer tube and holding member, the catalyst carrier can be produced simply and inexpensively and thus the manufacturing cost of the exhaust gas cleaning catalyst apparatus can be reduced.

### BRIEF DESCRIPTION OF THE DRAWINGS

The present invention will become more fully understood from the detailed description given hereinbelow and the accompanying drawing which is given by way of illustration only, and thus is not limitative of the present invention and wherein :

FIG. 1 is a side view of an exhaust gas cleaning catalyst apparatus according to an embodiment 1 of the invention, with its outer tube and holding member shown in section; and

FIG. 2 is a partially enlarged view of the embodiment 1.

### DETAILED DESCRIPTION OF THE INVENTION

Now, description is given specifically of a mode for carrying out the invention with reference to an embodiment shown in the drawings.

An exhaust gas cleaning catalyst apparatus of the embodiment 1 is disposed downstream of the engine of an automobile and, when letting exhaust gas discharged from the engine pass therethrough, is used to clean the harmful components of the exhaust gas such as carbon monoxide and nitrogen monoxide.

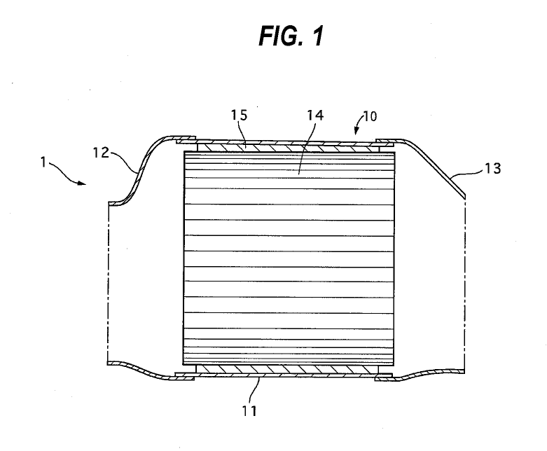

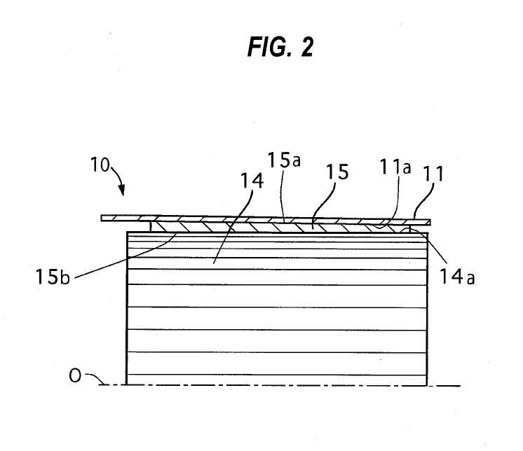

Firstly, the whole structure of the exhaust gas cleaning catalyst apparatus of the embodiment 1 is described with reference to FIGS. 1 and 2.

The exhaust gas cleaning catalyst apparatus 1 includes a metal-made outer tube 10, a catalyst carrier 14 to be stored within the outer tube 10, and a holding member 15 closely interposed between the inner peripheral surface of the metal-made outer tube 10 and the outer peripheral surface of the catalyst carrier 14.

The outer tube 10 includes a holding outer tube 11 disposed centrally thereof, an upstream outer tube 12 mounted and fixed to the upstream side of the holding outer tube 11, and a downstream outer tube 13 mounted and fixed to the downstream side of the holding outer tube 11.

The catalyst carrier 14 is stored through the holding member 15 into the holding outer tube 11. Specific description is given below of this storage structure.

The upstream outer tube 12 has a cross section expanding toward the flow direction of the exhaust gas, the leading end portion of the exhaust gas upstream side (in FIG. 1, the left side) thereof is connected to the downstream side of a manifold (not shown) provided on the exhaust port of the engine (not shown), and the exhaust gas downstream side (in FIG. 1, the right side) end portion thereof is fixed to the exhaust gas upstream end of the holding outer tube 11 while preventing the exhaust gas against leakage.

The downstream outer tube 13 has a cross section reducing toward the exhaust gas flow direction, the leading end portion of the exhaust gas upstream side thereof is fixed to the exhaust gas downstream side end of the holding outer tube 11 while preventing the exhaust gas against leakage, and the end portion of the exhaust gas downstream side thereof is connected to a muffler (not shown) through an exhaust pipe (not shown).

To produce the catalyst carrier 14, for example, long plate-shaped or corrugated metal foil and long corrugated metal foil are superimposed on each other while the plate-shaped (or corrugated) metal foil is situated outside, a winding shaft is secured to one end of the superimposed metal foil, multiple pieces of such superimposed metal foil are put on each other to form a rolled body, and the multi-wound metal foil is fixed by spot welding or the like, thereby constituting a honeycomb body.

Here, in this honeycomb body forming process, there is used, for example, a working apparatus similar to that disclosed in Japanese Patent Publication 2006-239580.

The holding member 15 is formed of heat-resistant fibers, for example, asbestos, rock wool, ceramic fibers, carbon fibers, glass fibers, slag wool and metal fibers into a tubular shape.

Next, description is given of a holding structure for holding the catalyst carrier 14 into the outer tube 10 through the holding member 15 with reference to FIG. 2.

In the holding outer tube 11 of the outer tube 10 for storing the catalyst carrier 14 therein, its inner peripheral surface 11a is formed such that it is inclined inward toward the flow direction (in FIG. 2, from left to right) of the exhaust gas so that its internal area reduces.

In the holding member 15, its outer peripheral surface 15a is inclined inward toward the exhaust gas flow direction (in FIG. 2, from left to right), whereas its inner peripheral surface 15b extends parallel to the center axis 0 of the holding member 15 but is not inclined. Thus, the holding member is formed such that its radial-direction thickness reduces from the upstream side to the downstream side of the exhaust gas.

Thus, a radial-direction clearance between the inner peripheral surface 11a of the holding outer tube 11 and the outer peripheral surface 14a of the catalyst carrier 14 narrows from the upstream side to downstream side of the exhaust gas.

Here, the outer peripheral surface of the catalyst carrier 14 is not inclined. This makes it possible to manufacture the catalyst carrier 14 simply and inexpensively.

As described above, in the exhaust gas cleaning catalyst apparatus of the embodiment 1, the catalyst carrier 14 and holding member 15 are inserted into the holding outer tube 11 toward the exhaust gas downstream side from its opening before the upstream outer tube 12 of the outer tube 10 is fixed to the holding outer tube 11.

In this case, they are inserted up to the position where the outer peripheral surface 15a of the holding member 15 is butted against the inner peripheral surface 11a of the holding outer tube 11 and is thereby prevented from advancing further.

At the then time, in the clearance between the inner peripheral surface 11a of the holding outer tube 11 and the outer peripheral surface 14a of the catalyst carrier 14, there are provided the outer and inner peripheral surfaces 15a and 15b of the holding member 15 in such a manner that they are contacted with the former two surfaces, thereby their securing positive sealing and holding performance for the catalyst carrier 14.

That is, the catalyst carrier 14 holding power by the holding outer tube 11 and holding member 15 is (surface pressure provided by holding member 15)×(friction coefficient between holding outer tube 11 and holding member 15)+(surface pressure provided by holding member 15)×(contact area between holding outer tube 11 and holding member 15)×sinθ. This holding power is larger by (surface pressure provided by holding member 15) ×(contact area between holding outer tube 11 and holding member 15)×sinθ than when no inclination angle is given. Here, θ is an inclination angle that the inner peripheral surface 11a of the holding member 11 and the outer peripheral surface 15a of the holding member 15 make for the outer peripheral surface 14a of the catalyst carrier 14.

In the above-structured exhaust gas clearing catalyst apparatus, when exhaust gas discharged from the engine passes from the upstream outer tube 12 through the catalyst carrier 14 within the holding outer tube 11, it is cleaned here. The cleaned exhaust gas is sent from the downstream outer tube 13 to the exhaust pipe or muffler and is thereafter discharged from a tail pipe (not shown) to the outside.

Here, supposing the catalyst carrier 15 is shifted in position relative to the holding outer tube 11 for some reason in the initial assembly or when in use, such position shift goes toward the exhaust gas downstream side due to the back pressure of the exhaust gas or the like. This further reduces the radial-direction clearance between the inner peripheral surface 11a of the holding member 11 and the outer peripheral surface 14a of the catalyst carrier 14, thereby increasing the power for holding the catalyst carrier 14.

As described above, the exhaust gas clearing catalyst apparatus of the embodiment 1 provides the following effects.

Since the inner peripheral surface 11a of the holding outer tube 11 and the outer peripheral surface 15a of the holding member 15 are formed to have an angle of inclination, when compared with the structure that no inclination angle is given, power for holding the catalyst carrier 14 can be increased, whereby the catalyst carrier 14 can be held more positively.

Therefore, use of a holding member 15 having small surface specific gravity is possible. Thus, the protrusion of the holding member 15 and the crack of the catalyst carrier 14 can be prevented. Also, there is eliminated the need for such severe control of the variation of the holding member 15 as in the prior art.

Since the upstream side opening area of the holding outer tube 11 is wider than that of the downstream side end of the holding member 15, the insertion of the holding member 15 into the holding outer tube 11 is facilitated.

The above effects can reduce the production cost of the exhaust gas clearing catalyst apparatus of the embodiment 1.

Also, since no inclination angle is given to the outer peripheral surface 14a of the catalyst carrier 14 and the inner peripheral surface 15b of the holding member 15, the catalyst carrier 14 can be produced similarly to the prior art, thereby being able to reduce an increase in the production cost.

Although the invention has been described heretofore with reference to the above embodiment, the invention is not limited to the same but, when the design and the like of the invention are changed without departing from the subject matter of the invention, such changes fall under the scope of the invention.

For example, the outer tube 10, catalyst carrier 14 and holding member 15 can be changed properly in their materials, shapes, structures and the like.

What is claimed is:

1. An exhaust gas cleaning catalyst apparatus, comprising:
a catalyst carrier;
an outer tube for storing the catalyst carrier; and
a holding member interposed between the catalyst carrier and the outer tube in contact with the outer peripheral surface of the catalyst carrier and the inner peripheral surface of the outer tube, wherein
a clearance between the inner peripheral surface of the outer tube and the outer peripheral surface of the catalyst carrier narrows toward the flow direction of exhaust gas.

2. An exhaust gas cleaning catalyst apparatus according to claim 1, wherein
the inner peripheral surface of the outer tube and the outer peripheral surface of the holding member are inclined toward the interiors of the outer tube and the holding member; and
the inner peripheral surface of the holding member and the outer peripheral surface of the catalyst carrier are extend parallel to the center axes of the outer tube and the holding member.
